(19) United States
(12) Patent Application Publication
(10) Pub. No.: US 2026/0013018 A1
(43) Pub. Date: Jan. 8, 2026

(54) LIGHTING EFFECT STRUCTURE FOR TRAMPOLINES

(71) Applicant: Shenzhen Blinngo Technology Co., Ltd., Shenzhen (CN)

(72) Inventor: Wanghui Xiong, Shenzhen (CN)

(21) Appl. No.: 19/266,294

(22) Filed: Jul. 11, 2025

(51) Int. Cl. H05B 47/115; F21S 4/20; F21V 23/00; F21V 23/02; F21V 23/04; F21V 33/00; F21Y 113/13; F21Y 115/10; H05B 45/20; H05B 47/16; H05B 47/17; H05B 47/175; H05B 47/19

(52) U.S. Cl. CPC H05B 47/115; F21S 4/20; F21V 23/008; F21V 23/023; F21V 23/0407; F21V 23/0435; F21V 23/0471; F21V 33/008; H05B 45/20; H05B 47/16; H05B 47/17; H05B 47/19; F21Y 2113/13; F21Y 2115/10; H05B 47/1965

(57) ABSTRACT

The present disclosure relates to the technical field of trampolines, specifically a lighting effect structure for trampolines. It includes a lighting effect control system, an LED light, and a remote controller. The lighting effect control system comprises a detection sensor and a PCB board, and the detection sensor is used to detect trampoline jumping actions in real time. By means of the lighting effect control system, trampoline jump vibrations instantly trigger a light response. Through the vibration sensor and the detection sensor integrated on the LED light, a child's jumping action is captured in all directions to accurately drive dynamic lighting effects. The multicolor light strip and multicolor light beads support independent DIY settings, allowing the user to freely select a single steady color or a multi-color flashing mode, and conveniently set a personalized flashing interval via the remote controller.

### TECHNICAL FIELD

The present disclosure relates to the technical field of trampolines, and more particularly to a lighting effect structure for a trampoline.

### BACKGROUND

Trampolining is a sport in which athletes use the rebound of a trampoline to perform acrobatic maneuvers in the air, a form of gymnastics known as “aerial ballet.” With the continual development of society, trampoline exercise has become increasingly popular, and some trampolines have even been equipped with lights for decoration to increase user interest.

However, the existing trampoline lighting structures have the following shortcomings in use: Because the trampoline's lights are powered by a standard power supply and use LED illumination of a fixed single color for lighting and decoration, the display during trampoline play is rigid and monotonous, and it cannot meet the demand for personalized DIY customization of lighting effects.

Therefore, we have proposed a lighting effect structure for a trampoline to solve the above problems.

### SUMMARY OF THE APPLICATION

### Technical Problem

In view of the deficiencies of the prior art, the present disclosure provides a trampoline lighting effect structure to address the issues of single, rigid lighting effects and the inability to customize trampoline light effects as noted in the background.

### Technical Solution

To achieve the above objective, the following technical solution is adopted:

A lighting effect structure for a trampoline includes a lighting effect control system, an LED light, and a remote controller. The lighting effect control system includes a detection sensor and a printed circuit board (PCB). The detection sensor is used to detect trampoline jumping actions in real time. The PCB integrates the following circuit modules:
a microcontroller unit,
a vibration sensor for detecting impact signals from the trampoline,
an LED driver that connects to and drives the LED light,
and a wireless transceiver for communicating with the remote controller.

The LED light comprises a flexible multicolor light strip and a plurality of multicolor light beads integrated on the light strip.

The input of the LED light is connected to the LED driver. The outputs of the detection sensor and the vibration sensor are electrically connected to the microcontroller unit, which synchronously processes the jump detection signals, vibration signals, and remote control commands to dynamically regulate the lighting effect mode of the LED light.

Further, the detection sensor is integrated on the multicolor light strip, with at least one detection sensor provided.

Further, the PCB board also integrates an antenna that is paired with the wireless transceiver, and the lighting effect control system also includes a control box with the PCB board arranged inside the control box.

Further, the control box also integrates a power switch and an input button located on one side of the power switch, and both the power switch and the input button are electrically connected to the PCB board.

Further, one side of the control box is detachably mounted with a battery pack and a battery cover for covering the battery pack, and the PCB board also integrates a power management module electrically connected to the battery pack.

Further, the remote controller is wirelessly connected to the PCB board via the wireless transceiver and the antenna, and the remote controller is provided with an ON button and an OFF button for starting and stopping the lighting effect control system.

Further, the remote controller is provided with several color selection buttons for setting the LED light's color, and a JUMP button for toggling between configuring the multicolor light strip or the multicolor light beads.

Further, the remote controller is also provided with a SPEED button for setting the LED light to flash and a TIME button for setting a flashing interval time.

Further, the structure also includes a trampoline main body. The trampoline main body comprises a trampoline chassis, a plurality of trampoline upright posts provided at the top of the trampoline chassis, a trampoline support frame at the bottom of the trampoline, and a trampoline enclosure net provided between the plurality of trampoline upright posts.

Further, one end of the LED light, which is far from the control box, is wound around to the top of the trampoline enclosure net and tied together with the trampoline enclosure net by a strap, and the control box is tied to the trampoline support frame by a strap.

### Advantages

Compared with the prior art, the provided trampoline lighting effect structure offers the following beneficial effects:

The lighting effect control system allows trampoline jumping vibrations to instantly trigger a light response. Through the vibration sensor and the detection sensor integrated on the LED light, children's jumping actions are captured in all directions, enabling precise dynamic lighting displays.

The multicolor light strip and multicolor light beads support independent DIY settings. Users can freely select a single-color always-on mode or a multi-color flashing mode, and conveniently set personalized flashing intervals via the remote controller. The integrated multicolor light strip and multicolor light beads structure combined with motion-sensing lighting effects significantly enhances the fun of trampoline play, meets the user's need for customized light colors and dynamic effects, and makes trampoline activities more interactive and visually attractive.

### BRIEF DESCRIPTION OF THE DRAWINGS

One or more embodiments are illustrated by the corresponding accompanying drawings, which are provided by way of example and are not intended to limit the embodiments. Elements identified by the same reference numerals in the drawings represent like or similar components. The drawings are not to scale and do not impose any dimensional limitations, and in the drawings:

FIG. 1 is a schematic structural diagram of the trampoline body structure with a lighting effect structure for trampolines according to the present disclosure;

FIG. 2 is an enlarged structural view of the trampoline portion shown in FIG. 1 of the lighting effect structure for a trampoline;

FIG. 3 is an exploded structural view of the lighting effect control system of the lighting effect structure for a trampoline;

FIG. 4 is a schematic view of the PCB board structure of the lighting effect structure for a trampoline;

FIG. 5 is a schematic view of the detection sensor structure of the lighting effect structure for a trampoline;

FIG. 6 is a schematic view of the remote controller structure of the lighting effect structure for a trampoline;

FIG. 7 is a principle block diagram of the lighting effect control system of the lighting effect structure for a trampoline;

FIG. 8 is a software programming architecture block diagram of the lighting effect control system of the lighting effect structure for a trampoline;

FIG. 9 is a circuit diagram of the LED driver's driving circuit in the lighting effect structure for a trampoline;

FIG. 10 is a circuit diagram of the wireless signal reception and demodulation in the lighting effect structure for a trampoline;

FIG. 11 is a schematic view of the lighting effect control system operating in an energy-saving state in the lighting effect structure for a trampoline.

In the drawings, the reference numbers denote the following components: 1—lighting effect control system; 11—detection sensor; 12—control box; 121—power switch; 122—input button; 123—battery pack; 124—battery cover; 13—PCB board; 14 micro control unit; 15—vibration sensor; 16—LED driver; 17—wireless transceiver; 18—antenna; 19—power management module; 2—LED light; 21—multicolor light strip; 22—multicolor light bead; 3—remote controller; 31—ON button; 32—OFF button; 33—color selection button; 34—JUMP button; 35—SPEED button; 36—TIME button; 4—trampoline main body; 41—trampoline chassis; 42 trampoline upright post; 43—trampoline support frame; 44—trampoline enclosure net; 45—strap.

### DETAILED DESCRIPTION

To more fully understand the features and technical content of the embodiments, a detailed description is given below in conjunction with the accompanying drawings. The drawings are for illustrative reference only and are not intended to limit the embodiments. In the following description, numerous details are set forth to provide a thorough understanding of the disclosed embodiments. However, one or more embodiments may still be implemented without certain specific details. In other instances, well-known structures and devices are depicted in simplified form in the drawings to avoid obscuring the embodiment details.

The terms “first,” “second,” and the like in the specification and claims of the embodiments of the present disclosure, as well as in the accompanying drawings, are used to distinguish similar elements and are not necessarily intended to describe any particular order or sequence. It should be understood that the data described with such terms may be interchanged where appropriate to implement the embodiments of the present disclosure described herein. Furthermore, the terms “comprise,” “include,” “have,” and any variations thereof are intended to cover non-exclusive inclusions.

In the present disclosure, positional or directional terms such as “upper,” “lower,” “inner,” “outer,” “front,” “rear,” etc., are used for convenience to describe relative positions in the drawings. These terms are used herein for descriptive purposes and should not be construed as limiting the described device or elements to any particular orientation. Moreover, some of these terms may be used to convey other meanings; for example, in certain contexts “upper” may indicate an attachment or connection relationship rather than a vertical direction. For those skilled in the art, the specific meanings of these terms in the context of the embodiments can be understood based on the particular circumstances.

Additionally, terms like “provided”, “connected”, and “fixed” are to be interpreted broadly. For example, “connected” can include fixed connection, detachable connection, or integral construction; it can be a mechanical or electrical connection; it can be directly connected or indirectly connected through an intermediate medium; or it may be an internal communication between two elements. Those skilled in the art will understand the specific meaning of these terms in context.

Unless otherwise specified, the term “multiple” means two or more.

It should be noted that, as long as there is no conflict, the embodiments and features described in this disclosure can be combined with each other.

### Embodiment

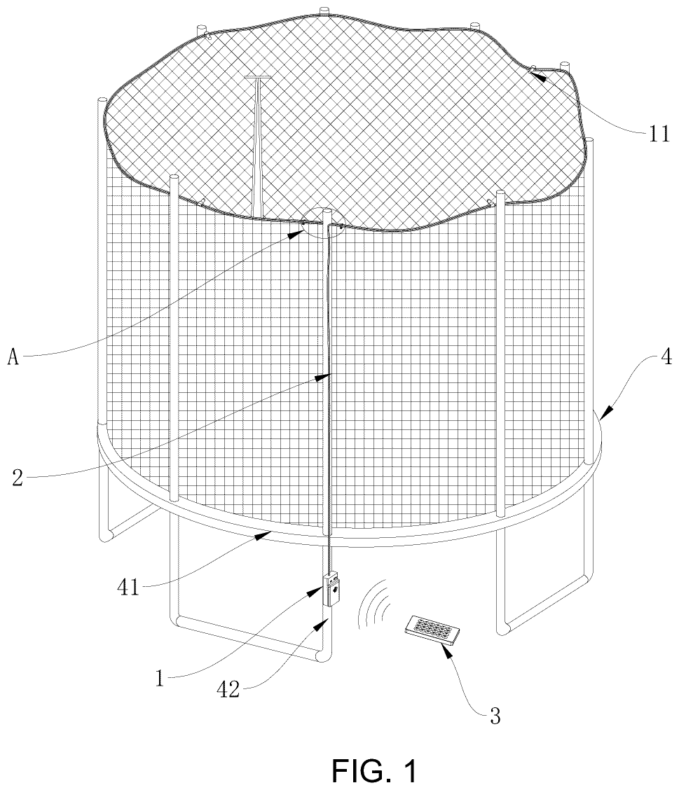

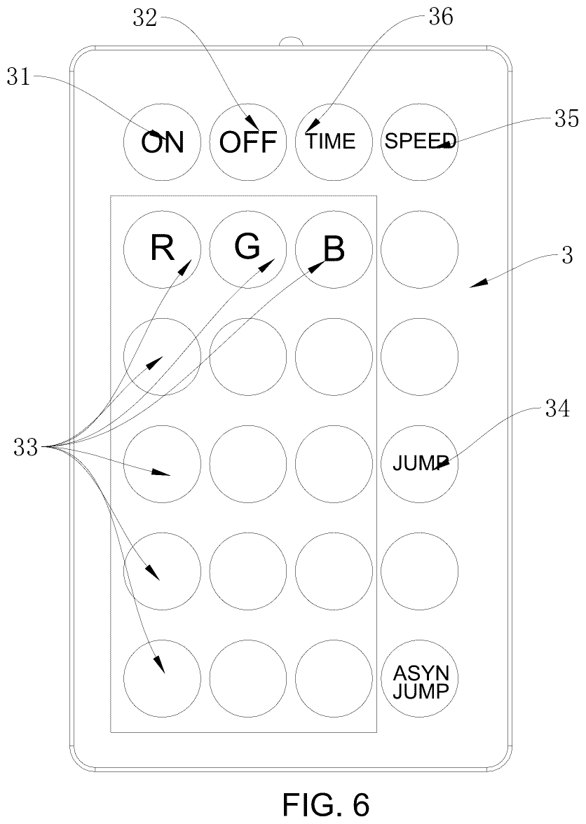

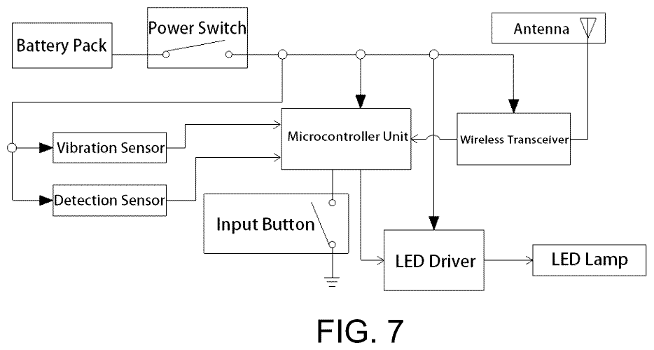

As shown in FIGS. 1-11, one embodiment of the present disclosure provides a lighting effect structure for a trampoline, which comprises a lighting effect control system 1, an LED light 2, and a remote controller 3. The lighting effect control system 1 includes a detection sensor 11 and a PCB board 13. The detection sensor 11 is used to detect trampoline jumping actions in real time. The PCB board 13 integrates the following circuit modules:
a micro control unit 14;
a vibration sensor 15 for detecting trampoline impact signals;
an LED driver 16 which is connected to and drives the LED light 2;
and a wireless transceiver 17 which communicates with the remote controller 3.

The LED light 2 comprises a multicolor light strip 21 and a plurality of multicolor light beads 22 integrated on the multicolor light strip 21. A plurality of multicolor light beads 22 are distributed at equal intervals along the multicolor light strip 21, and the multicolor light beads 22 and the multicolor light strip 21 are designed as an integrated structure to make the assembly more compact. The multicolor light strip 21 is flexible and can be bent to accommodate trampolines of different sizes and shapes.

The circuit input end of the LED light 2 is connected to the LED driver 16. The output of the detection sensor 11 and the output of the vibration sensor 15 are both electrically connected to the micro control unit 14. The micro control unit 14 synchronously processes the jump detection signals, vibration signals, and remote control commands to dynamically regulate the lighting effect mode of the LED light 2.

As shown in FIGS. 1-5, in some embodiments, the detection sensor 11 is integrated on the multicolor light strip 21, and the number of detection sensors 11 is at least one.

By providing multiple detection sensors 11 whose sensing directions are oriented vertically toward the trampoline bouncing surface, the system can detect a child's jumping posture on the trampoline in all directions with high accuracy. The detection sensor 11 is of a laser type. The circuitry of detection sensor 11 is integrated inside the multicolor light strip 21 and extends along the multicolor light strip 21 into the interior of the control box 12 to electrically connect with the PCB board 13.

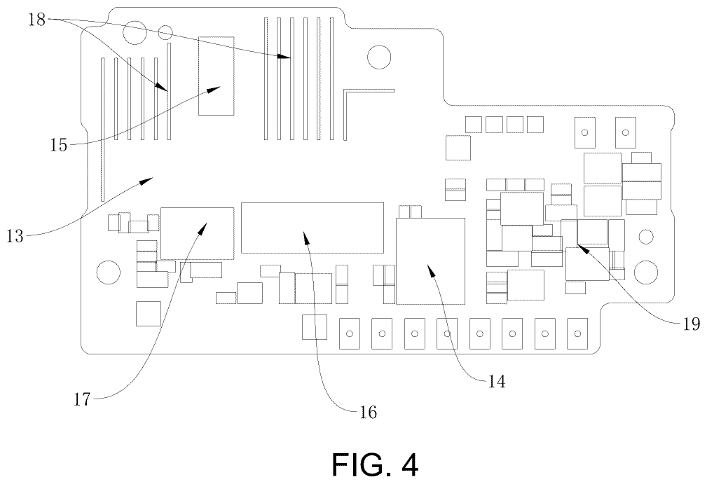

As shown in FIGS. 3-4, in some embodiments, the PCB board 13 also integrates an antenna 18 that matches the wireless transceiver 17. The lighting effect control system 1 further includes a control box 12, and the PCB board 13 is arranged inside the control box 12. The control box 12 further integrates a power switch 121 and an input button 122 located on one side of the power switch 121, both of which are electrically connected to the PCB board 13. One side of the control box 12 is detachably equipped with a battery pack 123 and a battery cover 124 covering the battery pack 123. The PCB board 13 also integrates a power management module 19 that is electrically connected to the battery pack 123.

The battery pack 123 consists of four AA batteries. The battery cover 124 is movably snap-fitted to the control box 12, so that by removing the battery cover 124 the battery pack 123 can be replaced. The battery pack 123 serves as the power input for the lighting effect control system 1 and provides power to the micro control unit 14, the vibration sensor 15, the detection sensor 11, the wireless transceiver 17, and the LED driver 16, as well as to the LED light 2. The micro control unit 14 serves as the core component of the system. This microcontroller unit is configured to execute the system program. It executes the system's program by collecting data from the vibration sensor 15 and the detection sensor 15 to determine whether a trampoline event has occurred. Based on this determination, the micro control unit 14 controls the LED driver 16 to drive the LED light 2, thereby displaying different lighting effects and providing feedback information to the end user.

The feedback signal is provided by different colors and flashing patterns of the LED light 2. Different feedback signals can be configured via the remote controller 3. The wireless signal sent by the remote controller 3 is received by the system's antenna 18 and then demodulated by the wireless transceiver 17, which outputs a baseband signal to the micro control unit 14 for processing, thereby setting the various user feedback signals. For convenience, when the remote controller 3 is not at hand, the system also includes the input button 122 on the control box 12 to allow the user to directly configure the LED light 2 feedback settings. The power switch 121 on the control box is used to turn the system's power on or off.

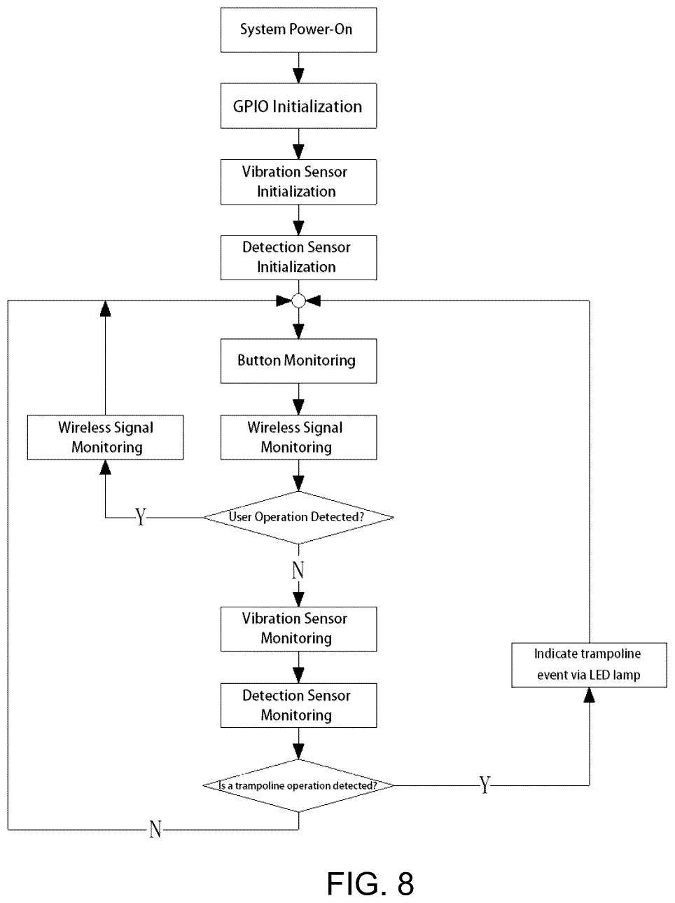

As shown in FIG. 8, the software programming architecture of the system operates as follows: when the system's power switch 121 is turned on, the system is powered up and the software begins executing code. The system first performs GPIO initialization of the micro control unit 14, then initializes the vibration sensor 15 and the detection sensor 11. Next, the system enters an infinite loop of tasks. In this loop, the system monitors the input button 122 and the input status of the wireless receiver. If a user input is detected, the system processes the input information and adjusts the LED light 2's feedback state, such as changing its color or brightness. When there is no user input, the software continues to collect signals from the vibration sensor 15 and the detection sensor 11, and through its algorithm determines whether a trampoline event is present. If a trampoline event is detected, the LED driver 16 drives the LED light 2 to display an event indication according to the user's pre-configured settings, and then the system proceeds to the next iteration of the loop.

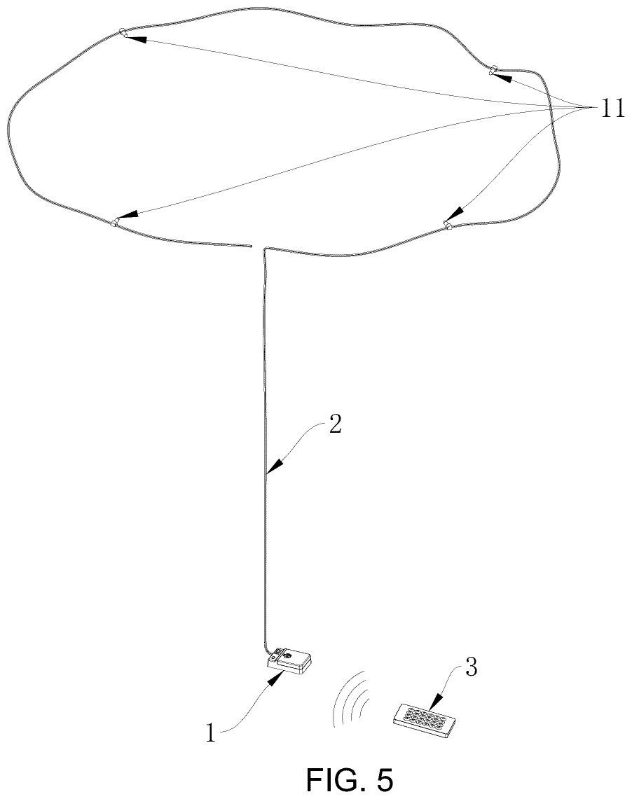

As shown in FIGS. 5-10, in some embodiments, the remote controller 3 communicates wirelessly with the PCB board 13 via the wireless transceiver 17 and the antenna 18. The remote controller 3 is provided with an ON button 31 to activate, and an OFF button 32 to deactivate, the lighting effect control system 1. The remote controller 3 is also provided with multiple color selection buttons 33 for setting the LED light 2's color, and a JUMP button 34 for toggling the configuration between the multicolor light strip 21 and the multicolor light beads 22. In addition, the remote controller 3 has a SPEED button 35 for setting the LED light 2 to flash, and a TIME button 36 for setting the flash interval.

### Lighting Effect Configuration for the LED Light 2:

The lighting effects of the LED light 2 can be configured via the remote controller 3's buttons. Press the ON button 31 to power on the lighting effect control system 1. Press the toggle button JUMP 34 to select either the multicolor light strip 21 or the multicolor light beads 22 for configuration, the selected lights will blink once to indicate selection, then press any color button within the “R, G, B color selection buttons 33” to set the desired color.

For example, the multicolor light strip 21 can be set to red while the light beads 22 are set to blue, and so on. This functionality allows different colors to be set, meeting the need for personalized DIY lighting effect customization. In addition to using the remote controller 3 for setting the lighting effects, the input button 122 on the control box 12 or a mobile trampoline app can also be used to configure settings.

The multicolor light strip 21 and multicolor light beads 22 can be set to flash in a single color, flash in multiple colors, or display in a marquee style. This diversity of settings completely satisfies the requirements for personalized DIY light effect displays. The specific configuration steps are as follows:

Press the “JUMP button 34” to select whether to configure the multicolor light strip 21 or the multicolor light beads 22. Once selected, the chosen light strip or light beads will flash once for confirmation. Press any of the R, G, B color selection buttons 33 to choose a color. The color can be red, green, blue, or any other available color.

After the color is selected: if continuous illumination is desired, press the “ON button 31” to confirm; if a flashing effect is desired, press the “SPEED button 35”, then press the “TIME button 36” to select a flashing interval. The system provides default interval options such as 3 seconds, 5 seconds, 7 seconds, and so on. After selecting the interval, press the “ON button 31” to confirm and complete the setting.

Once the colors and modes have been set, trampoline play can begin, and the lighting effects will respond to the jumping activity:
1.When a child jumps on the trampoline, the vibration sensor 15 in the control box 12 detects the vibration of the trampoline. The sensor 15 collects the vibration information and sends it to the micro control unit 14. The micro control unit 14, through its programmed logic, then drives the LED light 2 to display a corresponding lighting effect in response to the jump.
2.When the child bounces on the trampoline, the detection sensor 11 on the multicolor light strip 21 detects this jumping action. The detection sensor 11 sends the detected signal to the micro control unit 14, which then executes the programmed instructions to produce the appropriate lighting effect display.

In the program's logic, the micro control unit 14 processes the jump information from the detection sensor 11 before processing the vibration information from the vibration sensor 15. This prioritization effectively controls the lighting effect display of the multicolor light strip 21 and multicolor light beads 22 in scenarios such as when a child first steps onto the trampoline and then begins bouncing to trigger the lighting effects.

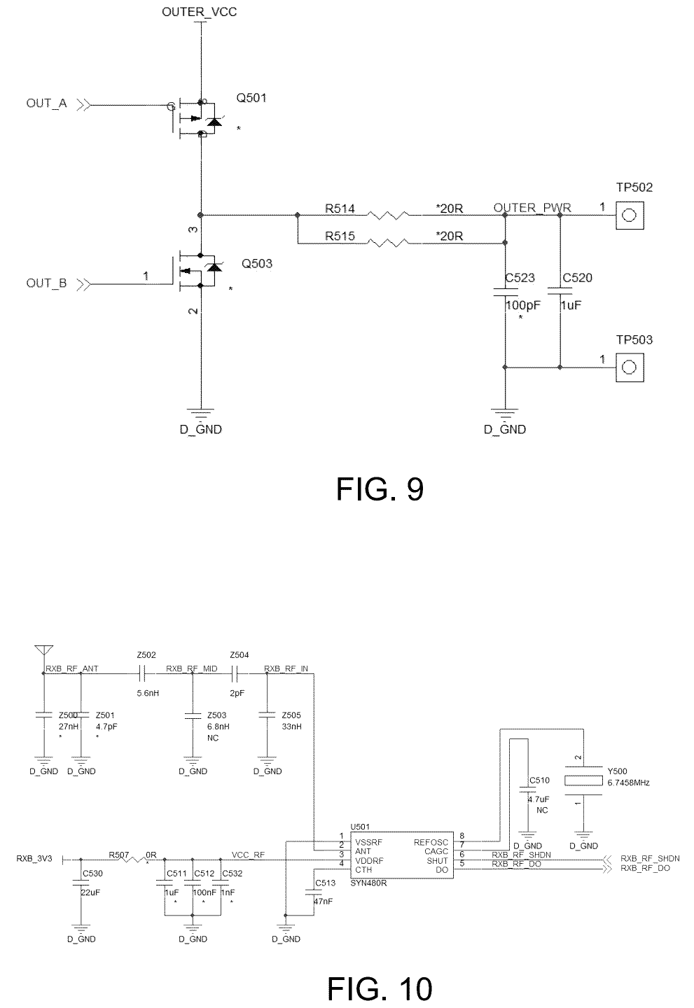

As shown in FIG. 9, in some embodiments, the LED driver 16's driving circuit is illustrated. In this circuit, OUTER_VCC is the power supply, and OUT_trampoline and OUT_B are control signals. TP502 and TP503 are output solder pads connected to the LED light 2. Q501 is a PMOS transistor and Q502 is an NMOS transistor. When OUT_trampoline is low and OUT_B is low, the output of the LED light 2 is at a high level. When OUT_trampoline is high and OUT_B is high, the output of the LED light 2 is low. The state where OUT_trampoline is low while OUT_B is high is not allowed. Two 20-ohm resistors are used in parallel to increase the output power of the LED light 2. The two capacitors at the output are designed to reduce EMC.

As shown in FIG. 10, in some embodiments, the wireless signal reception and demodulation circuit is illustrated. The wireless signal is received through the antenna 18 into U501 for demodulation, and then the RXB_RF_DO signal is input into the micro control unit 14 for processing, thereby obtaining the user's operation information.

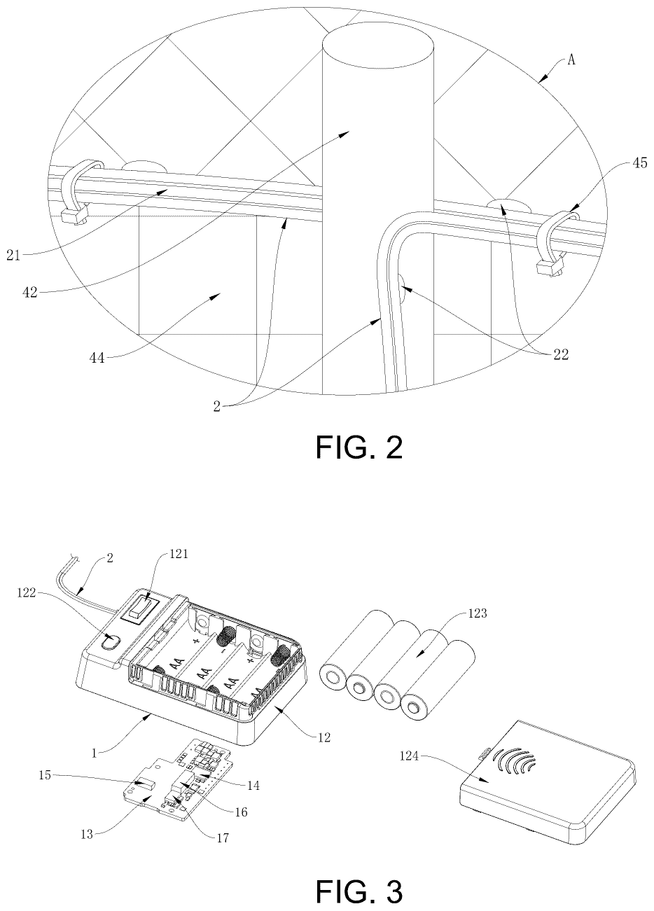

As shown in FIGS. 1-2, in some embodiments, the structure further includes a trampoline main body 4. The trampoline main body 4 includes a trampoline chassis 41, a plurality of trampoline upright posts 42 provided at the top of the trampoline chassis 41, a trampoline support frame 43 provided at the bottom of the trampoline, and a trampoline enclosure net 44 provided between the plurality of trampoline upright posts 42. One end of the LED light 2, which is far from the control box 12, is routed to the top of the trampoline enclosure net 44 and tied to the trampoline enclosure net 44 by a strap 45. The control box 12 is likewise tied to the trampoline support frame 43 using a strap 45.

Using the straps 45 for installation makes the setup more convenient. The inclusion of the trampoline enclosure net 44 improves safety during play by preventing users from falling off the trampoline main body 4. The strap 45 can also be replaced with a rope or secured with adhesive tape as an alternative means of installation.

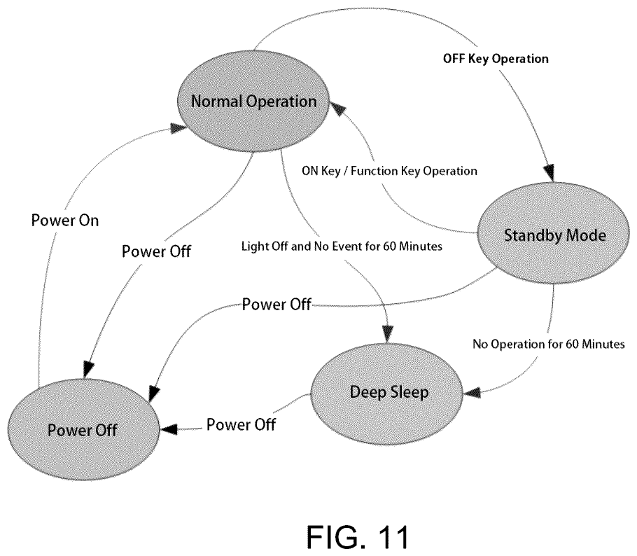

As shown in FIG. 11, in some embodiments, to conserve the energy of the battery pack 123 while providing sufficient power to the system, the system operates in the states illustrated in FIG. 11:

### Normal Mode:

The system's lights are on normally and the detection function is active, with the system at maximum power consumption. A set of four AA batteries in the battery pack 123 can power the system for about 48 hours in normal operation. In normal mode, if all lights are turned off and only the detection function is kept on, and no trampoline event or remote controller 3 input is detected for 60 consecutive minutes, the system will automatically enter a deep sleep state to conserve the energy of the battery pack 123.

### Normal Standby Mode:

Using the OFF button 32 on the remote controller 3 turns off the system, placing it in a standby state. If the ON button 31 on the remote controller 3 is pressed again within 60 minutes, or the input button 122 is pressed to return to normal operation mode, the system will resume normal functionality. In the standby state, the operating current is far lower than in normal working mode (note: about 0.2% of the battery pack 123's energy is consumed in 60 minutes of standby). In normal standby mode, the system can be reactivated by pressing the ON button 31 of the remote controller 3 or the input button 122.

### Deep Sleep Mode:

Deep sleep mode is an ultra-low power mode. Approximately 10% of the battery pack 123's energy is sufficient for the system to maintain operation for 2-3 years, which may be less than the battery pack's self-discharge consumption. After entering deep sleep mode, the system needs to be powered on again to restart.

### Power-Off Mode:

The power switch 121 is turned off, disconnecting the system from the battery pack 123, and no energy is consumed from the battery pack 123.

In summary, the lighting effect control system 1 of the present disclosure enables trampoline jump-induced vibrations to instantaneously trigger a lighting response. The combination of the vibration sensor 15 and the detection sensor 11 (integrated on the LED light 2) allows comprehensive capture of a child's jumping motions, thereby precisely driving dynamic lighting displays. The multicolor light strip 21 and multicolor light beads 22 support independent DIY configurations. The user may freely choose a steady single-color mode or a multi-color flashing mode for the lights, and conveniently set a personalized flashing interval using the remote controller 3. The integrated design of the multicolor light strip 21 and the multicolor light beads 22, together with motion-responsive lighting effects, greatly increases the entertainment value of trampoline play. It fulfills the user's need for customized light colors and dynamic effects, making trampoline activities more interactive and visually captivating.

Finally, it should be noted that the above embodiments are merely illustrative of the preferred embodiments of the present disclosure and not intended to limit the scope of the present disclosure. It will be understood by those skilled in the art that various modifications, substitutions, and improvements can be made to the described embodiments and technical solutions without departing from the spirit and scope of the present disclosure. Any such modifications, equivalent replacements, or improvements shall fall within the scope of protection of the present disclosure as defined by the appended claims.

1. A lighting effect structure for a trampoline, comprising:
A lighting effect structure for a trampoline includes a lighting effect control system, an LED light, and a remote controller. It is characterized in that the lighting effect control system comprises a detection sensor and a printed circuit board (PCB). The detection sensor is configured to detect trampoline jumping actions in real time. The PCB integrates the following circuit modules:
a micro control unit;
a vibration sensor for detecting trampoline impact signals;
an LED driver connected to and driving the LED light;
and a wireless transceiver for communication with the remote controller;
an LED light comprising a multicolor light strip and a plurality of multicolor light beads integrated on the multicolor light strip;
wherein a circuit input end of the LED light is connected to the LED driver, and output ends of the detection sensor and the vibration sensor are each electrically connected to the micro control unit such that the micro control unit synchronously processes jump detection signals, vibration signals, and remote control commands to dynamically regulate a lighting effect mode of the LED light.

2. The lighting effect structure according to claim 1, wherein the detection sensor is integrated on the multicolor light strip, and at least one detection sensor is provided.

3. The lighting effect structure according to claim 1, wherein the PCB board further integrates an antenna cooperating with the wireless transceiver, and the lighting effect control system further comprises a control box in which the PCB board is disposed.

4. The lighting effect structure according to claim 3, wherein the control box further comprises a power switch and an input button located on one side of the power switch, and both the power switch and the input button are electrically connected to the PCB board.

5. The lighting effect structure of claim 3, wherein one side of the control box is detachably provided with a battery pack and a battery cover for covering the battery pack, and the PCB board further integrates a power management module electrically connected to the battery pack.

6. The lighting effect structure of claim 1, wherein the remote controller is wirelessly connected to the PCB board via the wireless transceiver and the antenna, and the remote controller is provided with an ON button for activating the lighting effect control system and an OFF button for deactivating it.

7. The lighting effect structure of claim 1, wherein the remote controller is provided with a plurality of color selection buttons for setting the color of the LED light and a JUMP button for switching to configure the multicolor light strip or the multicolor light beads.

8. The lighting effect structure of claim 1, wherein the remote controller is further provided with a SPEED button for setting the LED light to flash and a TIME button for setting a flashing interval.

9. The lighting effect structure of claim 3, further comprising a trampoline main body, wherein the trampoline main body includes a trampoline chassis, a plurality of trampoline upright posts provided at the top of the trampoline chassis, a trampoline support frame provided at the bottom of the trampoline, and a trampoline enclosure net provided between the plurality of trampoline upright posts.

10. The lighting effect structure of claim 9, wherein one end of the LED light that is remote from the control box is routed to the top of the trampoline enclosure net and tied together with the trampoline enclosure net by a strap, and the control box is tied to the trampoline support frame by a strap.
